(19) United States
(12) Patent Application Publication
(10) Pub. No.: US 2025/0069823 A1
(43) Pub. Date: Feb. 27, 2025

(54) Housing Assembly and Electrical Switching Device, in Particular a Contactor or a Relay

(71) Applicants: Tyco Electronics Componentes Electromecanicos Lda, Evora (PT); TE Connectivity Solutions GmbH, Schaffhausen (CH)

(72) Inventors: Hugo FONTES, Berlin (DE); António Perdigão DUARTE SILVA, Evora (PT); Tiago TEIXEIRA, Evora (PT); Roman DIETRICH, Berlin (DE); Thomas HAEHNEL, Berlin (DE)

(73) Assignees: Tyco Electronics Componentes Electromecanicos Lda, Evora (PT); TE Connectivity Solutions GmbH, Schaffhausen (CH)

(21) Appl. No.: 18/811,851

(22) Filed: Aug. 22, 2024

(30) Foreign Application Priority Data
Aug. 24, 2023 (EP) 23398020.0

(51) Int. Cl. H01H 9/02; H01H 9/44

(52) U.S. Cl. CPC H01H 9/02; H01H 9/443

(57) ABSTRACT

A housing assembly for a contactor, wherein the housing assembly comprises a frame made of ferromagnetic material surrounding a contact chamber for separable contacts of the contactor, and an encloser made of insulative material at least in sections enveloping the frame internally and externally, wherein the encloser comprises at least one pocket for receiving a blow-out magnet of the contactor, wherein the frame is at least sectionwise exposed for contact in the at least one pocket. The frame improves the mechanical stability of the housing assembly and offers a suitable path for conducting the magnetic flux from the blow-out magnet. Further, the present invention relates to an electrical switching device with such a housing assembly.

This application claims priority to and the benefit of European Patent Application No. 23398020.0 filed Aug. 24, 2023, which is hereby incorporated by reference in its entirety.

### FIELD OF THE INVENTION

The present invention relates to a housing assembly for an electrical switching device, such as a contactor or relay. Further, the present invention relates to an electrical switching device, in particular a contactor or relay for high-voltage, automotive applications. However, the applicability of the present invention also extends to other fields of electrical engineering.

### BACKGROUND OF THE INVENTION

In general, electrical switching devices, such as contactors and relays, are used in the field of electrical engineering for closing or opening electrical circuits. The aim is to influence comparatively strong current flows with comparatively weak control currents. In particular, the control cur-rents are used for bringing together or moving apart separable contacts, which conduct the strong current flows.

In high-voltage applications in particular, interrupting strong current flows may lead to electric arcing. That is, an arc discharge occurs between the separable contacts, which may cause dam-age to components such as melting of conductors, destruction of insulation, and fire. In order to quickly extinguish the arc discharge, so-called blow-out magnets are often arranged near the separable contacts. These blow-out magnets are meant to create a magnetic force that stretches and eventually interrupts the arc discharge.

Yet, even if this or other kinds of arc quenching techniques are used, an electrical explosion commonly known as arc flash can occasionally take place and cause the electrical switching de-vice to burst. For example, a short-circuit in the electrical circuit of high-voltage applications can lead to excessive current flow. The resulting short-circuit current often induces strong repulsion forces between the separable contacts. If the repulsion forces manage to move the separable contacts away from each other, the resulting arc discharge leads to the generation of extremely high pressure and the above-mentioned arc flash. This represents a hazard to people and equipment that needs to be prevented.

### SUMMARY OF THE INVENTION

The object of the present invention is therefore to improve contactors and other electrical switching devices in terms of safety and reliability.

This object is achieved by a housing assembly of the aforementioned kind, wherein the housing assembly comprises a frame made of ferromagnetic material surrounding a contact chamber for separable contacts of the contactor, and an encloser made of insulative material at least in sections enveloping the frame internally and externally. The encloser may also be referred to as an enclosure or shell. The encloser comprises at least one pocket for receiving a blow-out magnet of the contactor, wherein the frame is at least sectionwise exposed for contact in the at least one pocket.

The above solution is advantageous, for at least two reasons:

First, the frame provides a mechanical reinforcement structure to the entire housing assembly. Therefore, if the housing assembly according to the present invention is used in a contactor or other kind of electrical switching device, and an arc flash was to happen occasionally, the frame can effectively prevent or at least mitigate a bursting of the housing assembly. In particular, the housing assembly provides increased safety in the event of a short-circuit.

Second, the frame's ferromagnetic material exhibits a low magnetic resistance compared to air, plastic or ceramics that normally surround blow-out magnets in conventional switches. Thus, in the present invention, when a blow-out magnet is received in the at least one pocket, the frame offers a suitable path for conducting the magnetic flux from the blow-out magnet. It is for this purpose that the frame is exposed for contact by the blow-out magnet in the at least one pocket. In other words, the frame is accessible for the blow-out magnet in the at least one pocket due to its exposure.

This allows the magnetic field of the blow-out magnet to better propagate in the contact chamber. The results are improved arc quenching and shortened electric arcing that contribute to safe and reliable operation of any electrical switching device employing the housing assembly according to the present invention.

The invention can be further improved by the following embodiments which are advantageous in themselves and which can be arbitrarily combined with one another.

According to one possible embodiment, the at least one pocket may adjoin the frame. In other words, a section of the frame may delimit one side of the pocket. This results in a compact structure, since the at least one pocket and the frame are directly adjacent to each other.

Alternatively, a separation wall may at least sectionwise separate the frame from the at least one pocket. In this case, the separation wall preferably comprises an access window through which the frame is exposed for contact by the blow-out magnet. Optionally, the frame and/or the blow-out magnet may comprise a projection capable of reaching through the access window. The access window allows to focus the contact between the frame and the blow-out magnet to a specific location that is suitable for the respective application.

According to another embodiment that is easy to manufacture, the frame may have a polyhedron shape with at least one side being open. For example, the frame may have an open-box shape formed by five, mutually perpendicular, rectangular faces. As such, the frame may be a deep drawn metal part. Alternatively, the frame may be a stamped and bent part, a forged part, a die-cast part or a 3-D printed part.

The at least one pocket and the contact chamber may both be open to one and the same side. In particular, the at least one pocket and the contact chamber may be open to the same side as the polyhedron-shaped frame. This facilitates the assembly process of the switching device, where the blow-out magnet is received in the at least one pocket and the separable contacts are arranged within the contact chamber. Both assembly steps can be carried out from the same direction and without the need to rotate or tilt the housing assembly.

According to a further embodiment, the housing assembly may comprise a lid for only closing the contact chamber sectionwise and the at least one pocket. That is, the lid may have at least one comparatively small opening through which the contact chamber communicates with the environment of the housing assembly. The size of the opening is chosen such that pressure equalization between the inside and outside of the contact chamber is decelerated by the opening. Thus, when electric arcing occurs, the resulting high pressure is temporarily sustained inside the con-tact chamber. Keeping the pressure high for the duration of the arc discharge helps arc extinction.

Optionally, at least one edge of the frame may protrude from the encloser. Further, the housing assembly may comprise a base plate that is weldable to the least one protruding edge of the frame. Preferably, the at least one protruding edge of the frame encircles the contact chamber and the at least one pocket. Correspondingly, the base plate may be welded to the at least one edge. The above-mentioned lid may be positioned between the frame and the base plate. Thus, the base plate may mechanically reinforce the lid in the same manner as the frame reinforces the encloser.

Alternatively, if no separate lid or base plate are provided, the housing assembly may be directly welded e.g. to a housing of an actuator, such as a solenoid or any other type of coil assembly.

According to another embodiment, the encloser may comprise an inner wall, lining the contact chamber on the inside, and an outer wall, encasing the frame on the outside, wherein the frame is positioned between the inner wall and the outer wall. In other words, the frame is sandwiched between the inner wall and the outer wall. Thereby, the frame can be effectively insulated from the separable contacts in the contact chamber and at the same time be provided with an external touch protection.

In order to simplify the handling of the housing assembly, the frame and the encloser may jointly form a monolithic structure. In particular, no additional, separate components are required, since the frame and the encloser are a single unit in this embodiment. For example, the inner wall and the outer wall may be overmolded on the frame. Thereby, the inner wall is embodied by an inner layer of the insulative material, while the outer wall is embodied by an outer layer of the insulative material.

Optionally, the frame may comprise at least one feed-through hole leading into the contact chamber. During the overmolding process, a material build-up of the insulative material may be created in the at least one feed-through hole connecting the inner layer with the outer layer. This increases cohesion between the frame and encloser.

Alternatively, the inner wall and the outer wall may be prefabricated elements mounted on the frame. In particular, the prefabricated elements may be precast from the insulative material. This embodiment allows for easier maintenance, since the prefabricated elements may be replaced when needed.

It is also conceivable that only the inner wall or outer wall is a prefabricated element mounted on the frame, while the respective other wall is overmolded on the frame.

The above-mentioned separation wall may be part of the encloser. Further, the separation wall may also be embodied by a prefabricated element mounted between the frame and the blow-out magnet or by a separation layer of the insulative material injected between the frame and the blow-out magnet.

According to another embodiment, the at least one pocket may be formed by the inner wall. Thereby, the frame can surround the blow-out magnet received in the at least one pocket. Hence, the frame can serve as a shielding against the magnetic field of the blow-out magnet at least to a certain extent.

Preferably, the encloser may comprise at least two pockets in order to increase the number of blow-out magnet that can be received by the housing assembly. This in turn improves the arc quenching capability.

Optionally, the at least two pockets may be arranged opposite each other with respect to the con-tact chamber. In other words, the contact chamber may be located between the at least two pockets. Consequently, the blow-out magnets can be arranged on at least two opposite sides of the contact chamber, thereby improving their arc quenching effect.

The object defined in the outset can also be satisfied by an electrical switching device, in particular a contactor, for example a DC contactor or an AC contactor, or a relay, wherein the switching device comprises a housing assembly according to any one of the above-explained embodiments, a contact assembly with separable contacts located in the contact chamber of the housing assembly, and at least one blow-out magnet positioned within the at least one pocket of the encloser and in direct contact with the frame.

The switching device benefits from the technical effect and advantages of the housing assembly as explained above. In particular, the safety and reliability of the switching device is improved due to the presence of the housing assembly.

According to one possible embodiment, the at least one blow-out magnet may be a permanent magnet and the magnetic flux of the at least one blow-out magnet may be conducted through the frame. Besides improving the propagation of the magnetic field into the contact chamber, this embodiment is advantageous, since no separate fixation means for the at least one blow-out magnet is required. The magnetic attraction between the permanent magnet and the ferromagnetic frame automatically assumes a fixation function. Preferably, one blow-out magnet is provided for each pocket of the housing assembly.

Moreover, a back side and/or a lateral side of each blow-out magnet facing away from the con-tact chamber may be in direct contact with the frame. If two blow-out magnets are provided, the back side and/or the lateral side faces away from the respective other blow-out magnet, when the blow-out magnets are arranged on opposite sides with respect to the contact assembly. This creates a so-called magnetic re-coupling of the blow-out magnets which connects the respective back sides and/or the lateral sides via the frame.

Optionally, the switching device may comprise a coil assembly for actuating the contact assembly. The housing assembly and the contact assembly may be arranged on the coil assembly. A plunger of the coil assembly may reach into the housing assembly. The plunger may transfer an actuation force and a resulting actuation movement from the coil assembly to the separable contacts of the contact assembly. Alternatively, manual actuation may also be utilized.

Further, the switching device may optionally be configured to have a plurality of connection sections. A power cable can be provided for each connection section and be fastened to and contacted on the associated connection section. The switching device can comprise, in particular, a plurality of fastening elements, contacting elements, and/or current-carrying elements at the connection sections. The connection sections are interconnected via the contact assembly and its separable contacts.

### BRIEF DESCRIPTION OF THE DRAWINGS

The invention shall be explained in more detail hereafter by way of example with reference to the drawings. The feature combinations illustrated in the embodiments shown by way of example can be supplemented by further features in accordance with the above statements in correspondence with the properties of the invention required for a specific application. Individual features can also be omitted in accordance with the above statements from the embodiments described if the effect of these features is of no relevance for a specific application. The same reference numerals in the drawings are always used for elements having the same function and/or the same structure.

FIG. 1 shows a schematic perspective illustration of a housing assembly according to an exemplary embodiment;

FIG. 2 shows another schematic perspective illustration of the housing assembly from FIG. 1;

FIG. 3 shows a schematic perspective illustration of the housing assembly according to a further exemplary embodiment in exploded sectional view;

FIG. 4 shows a schematic sectional side view of an electrical switching device according to an exemplary embodiment;

FIG. 5 shows a schematic sectional side view of the housing assembly according to another exemplary embodiment;

FIG. 6 shows a schematic exploded sectional side view of the housing assembly according to another exemplary embodiment;

FIG. 7 shows a schematic perspective illustration of a frame and bottom plate of the housing assembly according to a further exemplary embodiment; and

FIG. 8 shows another schematic sectional illustration of the frame and bottom plate from FIG. 5.

### DETAILED DESCRIPTION OF THE INVENTION

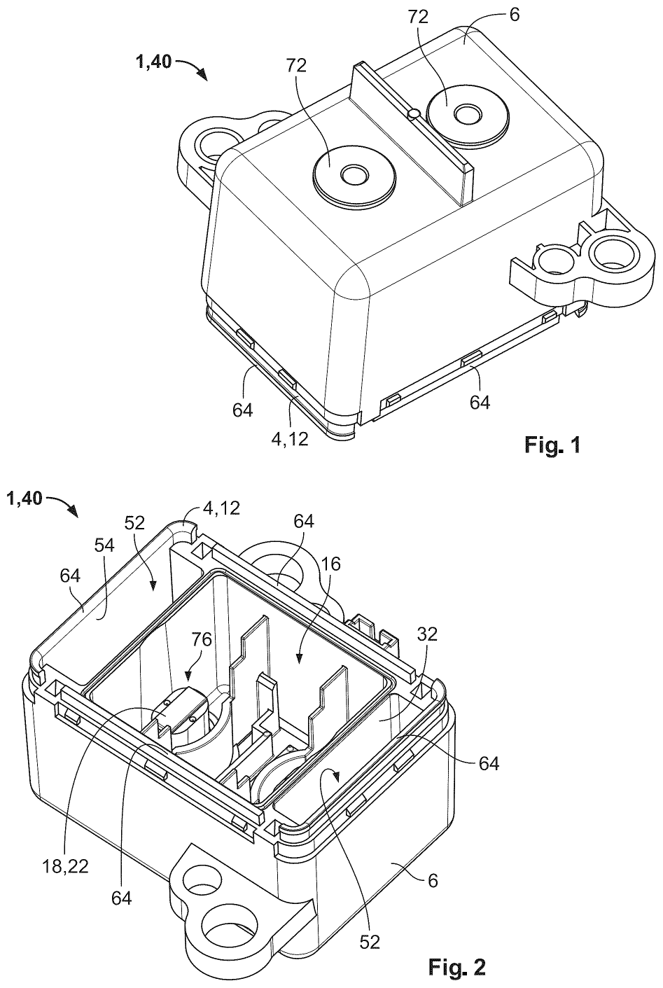

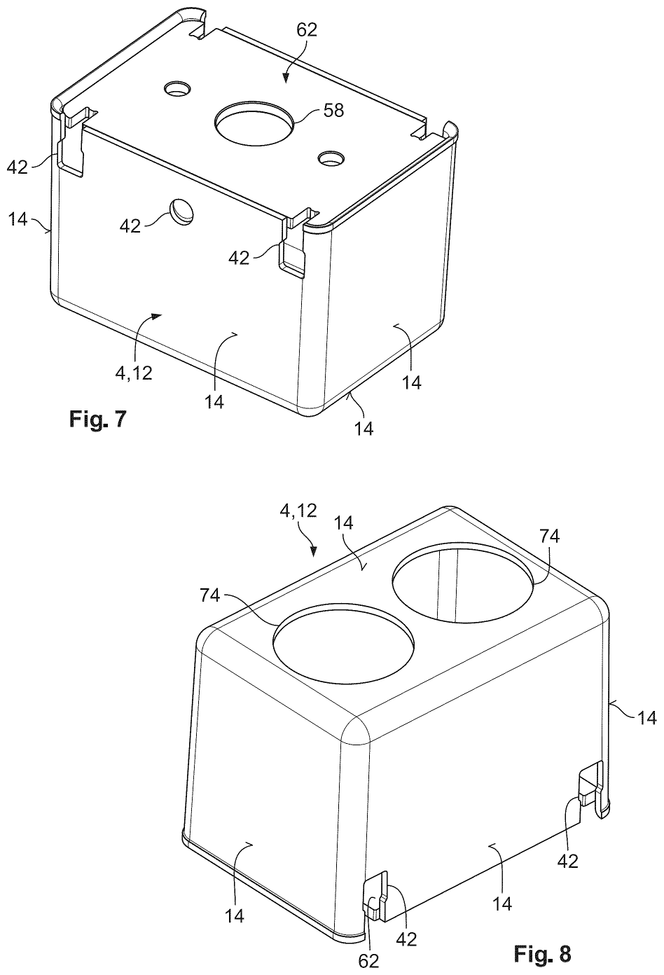

In the following, the schematic structure of a housing assembly 1 and an electrical switching de-vice 2 according to the invention will be explained with reference to FIGS. 1 to 8.

As can be seen in the schematic perspective views of FIGS. 1 and 2, the housing assembly 1 comprises a frame 4 and an encloser 6 at least in sections enveloping the frame 4 internally and externally. The encloser 6 may also be referred to as an enclosure or shell.

The housing assembly 1 is meant to be used for the electrical switching device 2, which could be, for example, an encloser 6 or relay 10. As will be described in further detail below, the housing assembly 1 can contribute to an increase of the safety and reliability of the electrical switching device 2.

In particular, the frame 4 provides a mechanical reinforcement structure to the entire housing assembly 1. That is, the frame 4 is made of ferromagnetic material, in particular a ferromagnetic metal. For example, the frame 4 may be a deep drawn metal part 12 (see FIG. 6). Alternatively, the frame 4 may be a stamped and bent part, a forged part, a die-cast part or a 3-D printed part.

In the shown embodiments, the frame 4 has an open-box shape formed by five, mutually perpendicular, rectangular faces 14 (see FIG. 7). More generally, the frame 4 may have a polyhedron shape with at least one side being open. With its shape, the frame 4 surrounds a contact chamber 16 for separable contacts 18 of a contact assembly 20 of the switching device 2.

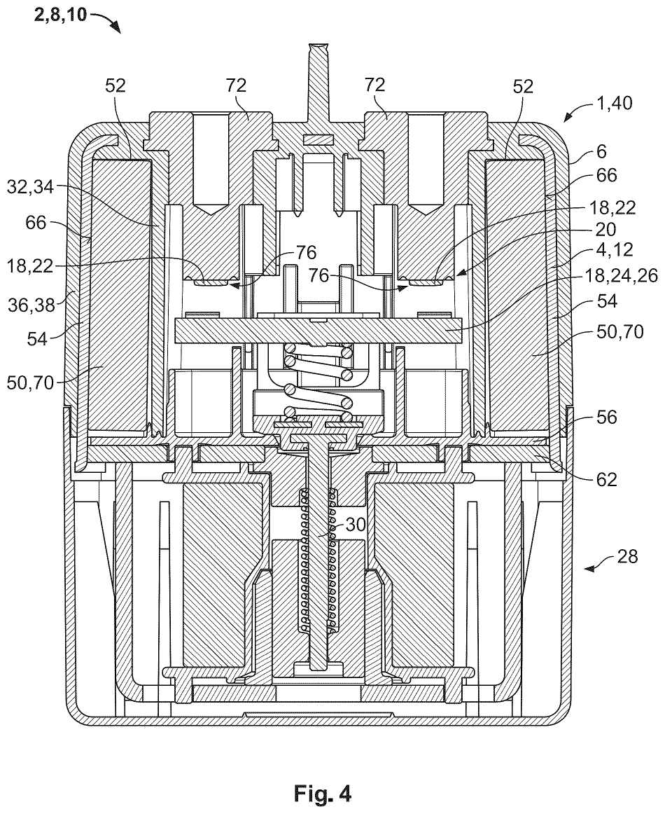

The separable contacts 18 may comprise at least one stationary contact 22 and at least one movable contact 24, all exhibiting high electric conductivity. For example, the movable contact 24 may be a contact bridge 26 spanning between two stationary contacts 22 that are arranged within the contact chamber 16 (see FIG. 4).

The switching device 2 may comprise a coil assembly 28 for actuating the contact bridge 26. The housing assembly 1 and the contact assembly 20 may be arranged on the coil assembly 28. A plunger 30 of the coil assembly 28 may reach into the housing assembly 1. The plunger 30 may transfer an actuation force and a resulting actuation movement from the coil assembly 28 to the contact bridge 26. Alternatively, manual actuation may also be utilized.

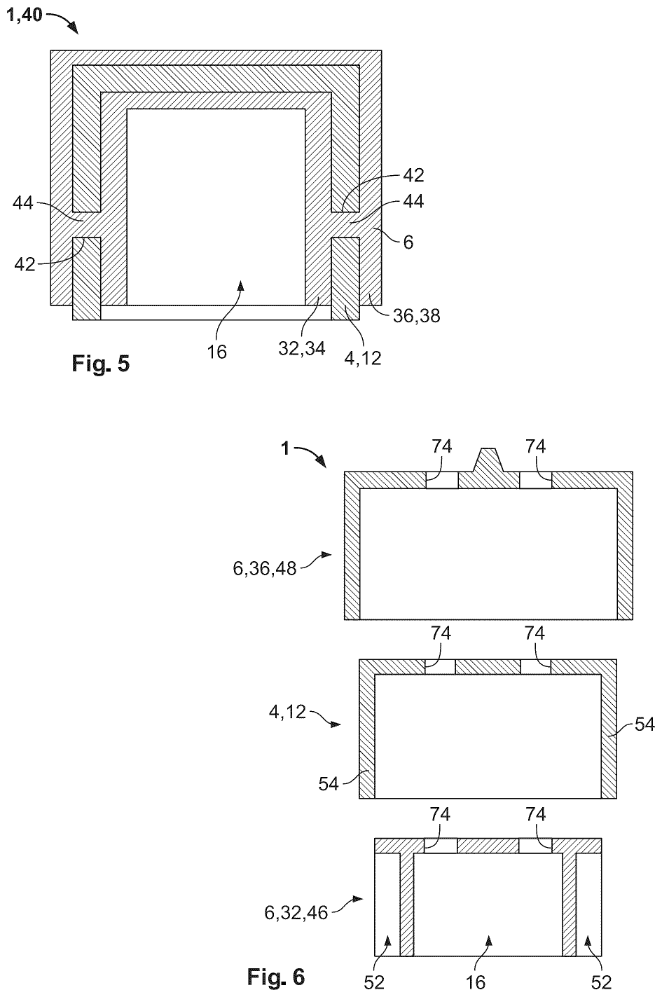

The encloser 6 separates the frame 4 from the contact chamber 16. For this purpose, the encloser 6 is made of insulative material and may comprise an inner wall 32, lining the contact chamber 16 on the inside. In particular, the inner wall 32 may be embodied by an inner layer 34 of the insulative material overmolded on the frame 4 (see FIG. 5).

Further, the encloser 6 may provide an external touch protection. As such, the encloser 6 may comprise an outer wall 36, encasing the frame 4 on the outside. Accordingly, the outer wall 36 may be embodied by an outer layer 38 of the insulative material. Again, the outer layer 38 may be overmolded on the frame 4 (see FIG. 5).

In other words, the inner wall 32 and the outer wall 36 may both be overmolded on the frame 4. Thus, the frame 4 and the encloser 6 may form a monolithic structure 40. Optionally, the frame 4 may comprise at least one feed-through hole 42 leading into the contact chamber 16. During the overmolding process, a material build-up 44 of the insulative material may fill out the at least one feed-through hole 42 connecting the inner layer 34 with the outer layer 38.

According to an alternative embodiment shown in FIG. 6, the inner wall 32 may be a prefabricated element 46 mounted on the frame 4. Likewise, the outer wall 36 may also be a prefabricated element 48 mounted on the frame 4. Herein, the frame 4 is positioned, in particular sandwiched between the inner wall 32 and the outer wall 36.

The ferromagnetic properties of the frame 4 can be further exploited in combination with blow-out magnets 50 of the switching device 2. These blow-out magnets 50 are arranged near the separable contacts 18 in order to quickly extinguish arc discharges occurring between the stationary contacts 22 and the movable contacts 24. In particular, the blow-out magnets 50 create a magnetic force that stretches and eventually interrupts the arc discharge.

The frame 4 offers a suitable path for conducting the magnetic flux from the blow-out magnets, since the frame 4 exhibits a low magnetic resistance compared to air, plastic or ceramics that normally surround blow-out magnets in conventional switches (not shown). This allows the magnetic field of the blow-out magnets 50 to better propagate in the contact chamber 16 and helps extinguishing the arc discharges.

To accommodate the blow-out magnets 50 of the switching device 2, the encloser 6 comprises one pocket 52 for every blow-out magnet 50. The frame 4 is at least sectionwise exposed in these pockets 52 for contact by the corresponding blow-out magnet 50. In other words, the frame 4 is accessible for the blow-out magnets 50 in the respective pockets 52 due to exposure.

As can be seen in FIG. 2, the pockets 52 may adjoin the frame 4. That is, a section 54 of the frame 4 may delimit one side of each pocket 52. Alternatively, a separation wall (not shown) may at least sectionwise separate the frame 4 from the corresponding pocket 52. In this case, the separation wall preferably comprises an access window through which the frame is exposed for contact by the blow-out magnet. Optionally, the frame and/or the blow-out magnet may comprise a projection reaching through the access window.

As can further be seen in FIG. 2, the pockets 52 and the contact chamber 16 may both be open to one and the same side. In particular, the pockets 52 and the contact chamber 16 may be open to the same side as the frame 4 is.

Preferably, the pockets 52 may be formed by the inner wall 32 (see FIG. 6). Thereby, the frame 4 can surround the blow-out magnets 50 received in the respective pockets 52 as can be seen in FIG. 4. Further, the pockets 52 may be arranged opposite each other with respect to the contact chamber 16. In other words, the contact chamber 16 may be located between the pockets 52. Consequently, the blow-out magnets 50 can be arranged on two opposite sides of the contact chamber 16.

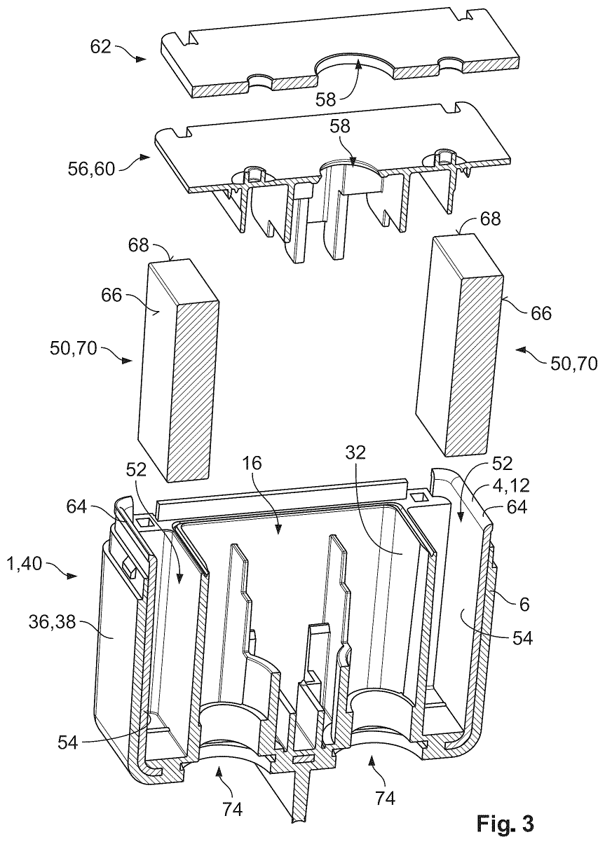

To close the contact chamber 16 and the pockets 52, the housing assembly 1 may comprise a lid 56 (see FIG. 3). The lid 56 may be configured to cover most of the contact chamber 16 and the pockets 52. Further, the lid 56 may have at least one opening 58, through which the contact chamber 16 communicates with the environment of the housing assembly 1. The size of the at least one opening 58 is chosen such that pressure equalization between inside and outside of the contact chamber 16 is decelerated.

The above-mentioned plunger 30 of the coil assembly 28 may reach into the contact chamber 16 through the opening 58 of the lid 56 and be connected in a force- and displacement-transmitting manner to the contact bridge 26 (see FIG. 4). Thereby, an actuation force originating from the coil assembly 28 may be transferred via the plunger 30 and move the contact bridge 26. If multiple contact bridges are provided, the plunger 30 of the coil assembly 28 may be connected to at least one of those contact bridges.

The lid 56 may be a prefabricated element 60 that is mounted to the frame 4 and/or encloser 6. Preferably, the lid 56 is made of insulative material. As a structural reinforcement of the lid 56, the housing assembly 1 may comprise a base plate 62 made of ferromagnetic material, in particular a ferromagnetic metal. The base plate 62 may be mounted to the frame 4 and/or encloser 6. The lid 56 may be positioned between the frame 4 and the base plate 62.

Optionally, at least one edge 64 of the frame 4 may protrude from the encloser 6 (see FIG. 2). In this embodiment, the base plate 62 is weldable to the protruding edge 64 of the frame 4. Preferably, the protruding edge 64 of the frame 4 encircles the contact chamber 16 and the pockets 52. Correspondingly, the base plate 62 may be welded to the protruding edge 64 along the entire circumference of the contact chamber 16 and pockets 52. Thus, the frame 4 and base plate 62 jointly form a highly pressure resistant structure.

In an alternative embodiment not shown in the figures, the housing assembly 1 may be directly welded e.g. to a housing of an actuator, such as a solenoid or other type of coil assembly. This way, no separate lid or base plate has to be provided.

Other ways of attaching the frame 4 to the base plate 62 or the housing of the actuator may include bending, pressing, riveting, screwing, gluing and the like techniques for establishing a rigid connection.

As already mentioned above, the switching device 2 comprises the housing assembly 1, the con-tact assembly 20 with the separable contacts 18 located in the contact chamber 16 of the housing assembly 1 and blow-out magnets 50 positioned within the pockets 52 of the encloser 6.

The blow-out magnets 50 are in direct contact with the frame 4. In particular, a back side 66 of each blow-out magnet 50 facing away from the contact chamber 16 may be in direct contact with the frame 4. Additionally or alternatively, the lateral sides 68 of each blow-out magnet 50 may be in direct contact with the frame 4. Preferably, the blow-out magnets 50 may be permanent mag-nets 70 and their respective magnetic flux may be conducted through the frame 4.

The base plate 62 may be positioned between the contact chamber 16 and the coil assembly 28 (see FIG. 4). As already described above, the base plate 62 has ferromagnetic properties. This allows the base plate 62 to conduct magnetic flux originating from the coil assembly 28, which improves the operation of the coil assembly 28.

As further shown in FIG. 4, the switching device 2 may optionally be configured having a plurality of connection sections 72. A power cable (not shown) can be provided for each connection section 72 and fastened thereto. For this purpose, a fastening element (not shown) may be present on each connection section 72. Alternatively, each power cable may be welded or soldered to the connection section 72.

The connection sections 72 may extend through the outer wall 36, the frame 4 and the inner wall 32 into the contact chamber 16 (see FIG. 4). For this purpose, appropriate apertures 74 may be provided in the outer wall 36, the frame 4 and/or the inner wall 32 (see FIG. 6).

Ends 76 of the connection sections 72 that extend into the contact chamber 16 may serve as the above-mentioned stationary contacts 22. These stationary contacts 22 may be interconnected via the contact bridge 26. This interconnection is interrupted, when the contact bridge 26 is moved away from the stationary contacts 22 by means of the coil assembly. Any arc discharge that occurs during this separation process is quenched by means of the blow-out magnets 50.

The electrical switching device 2 shown as the encloser 6 can be a DC contactor or an AC contactor. Alternatively, the present invention can also be used in relays 10 or similar electrical switches.

### REFERENCE NUMERALS

1 housing assembly
2 switching device
4 frame
6 encloser
8 contactor
10 relay
12 part
14 face
16 contact chamber
18 separable contact
20 contact assembly
22 stationary contact
24 movable contact
26 contact bridge
28 coil assembly
30 plunger
32 inner wall
34 inner layer
36 outer wall
38 outer layer
40 monolithic structure
42 feed-through hole
44 material build-up
46 prefabricated element
48 prefabricated element
50 blow-out magnet
52 pocket
54 section
56 lid
58 opening
60 prefabricated element
62 base plate
64 edge
66 back side
68 lateral sides
70 permanent magnet
72 connection section
74 aperture
76 end

1. A housing assembly for a contactor, wherein the housing assembly comprises:
a frame made of ferromagnetic material surrounding a contact chamber for separable contacts of the contactor; and
an encloser made of insulative material at least in sections enveloping the frame internally and externally;
wherein the encloser comprises at least one pocket for receiving a blow-out magnet of the contactor;
wherein the frame is at least sectionwise exposed for contact in the at least one pocket.

2. The housing assembly according to claim 1, wherein the at least one pocket adjoins the frame.

3. The housing assembly according to claim 1, wherein the frame has a polyhedron shape with at least one face being open.

4. The housing assembly according to claim 1, wherein the housing assembly comprises a lid for only sectionwise closing the contact chamber.

5. The housing assembly according to claim 1, wherein at least one edge of the frame protrudes from the encloser and wherein the housing assembly comprises a base plate that is weldable to the least one edge of the frame.

6. The housing assembly according to claim 1, wherein the encloser comprises an inner wall, lining the contact chamber on the inside, and an outer wall, encasing the frame on the outside, wherein the frame is positioned between the inner wall and the outer wall.

7. The housing assembly according to claim 1, wherein the frame and the encloser form a monolithic structure.

8. The housing assembly according to claim 6, wherein the inner wall and the outer wall are overmolded on the frame.

9. The housing assembly according to claim 6, wherein the inner wall and the outer wall are pre-fabricated elements mounted on the frame.

10. The housing assembly according to claim 6, wherein the at least one pocket is formed by the inner wall.

11. The housing assembly according to claim 1, wherein the encloser comprises at least two pockets.

12. The housing assembly according to claim 11, wherein the at least two pockets are arranged opposite each other with respect to the contact chamber.

13. A switching device comprising a housing assembly according to claim 1, a contact assembly with separable contacts located in the contact chamber of the housing assembly and at least one blow-out magnet positioned within the at least one pocket of the encloser and in direct contact with the frame.

14. Switching device according to claim 13, wherein the at least one blow-out magnet is a permanent magnet and the magnetic flux of the at least one blow-out magnet is conducted through the frame.

15. Switching device according to claim 13, wherein a back side of each blow-out magnet facing away from the contact chamber is in direct contact with the frame.
